(19) United States
(12) Patent Application Publication
(10) Pub. No.: US 2026/0225094 A1
(43) Pub. Date: Aug. 6, 2026

(54) COUPLING DEVICES FOR PIPETTE TIPS

(71) Applicant: RITTER GMBH, Schwabmünchen (DE)

(72) Inventor: Frank FINIS, Augsburg (DE)

(21) Appl. No.: 19/153,291

(22) PCT Filed: Feb. 14, 2024
(86) PCT No.: PCT/EP2024/053671

§ 371 Date: Aug. 1, 2025

(30) Foreign Application Priority Data
Feb. 15, 2023 (DE) 10 2023 103 701.3

(51) Int. Cl. B01L 3/02; G01N 35/00

(52) U.S. Cl. CPC B01L 3/0279; G01N 35/0099; B01L 2200/0689

(57) ABSTRACT

A coupling device has a jacket and a basic body portion. Inside the jacket there is a chuck having moveable chucking elements. Furthermore, the coupling device has an actuation element. When the actuation element is in a first position, the chucking elements are in a retracted position. When the actuation element is moved into a second position the chucking elements move outside into an expanded state, e.g., to engage positively with an inner wall surface of a pipette tip.

### TECHNICAL FIELD

The application relates to coupling devices for pipette tips, particularly for pipette tips as described in WO2023/088850 A1.

### BACKGROUND

Many pipette tip coupling devices for use with pipetting robots are known in the prior art. Usually coupling devices are designed for gripping pipette tips and/or for providing a sealing between the pipette tip and the coupling device.

### SUMMARY

The present disclosure presents various coupling devices for use with pipette tips which are adapted to a respective coupling device.

A pipette tip used in combination with a coupling device of the present disclosure comprises a first upper section which receives a gripping jacket, and a lower section which receives a basic body portion of the coupling device.

The jacket comprises a hollow in which a collet or chuck is arranged. The collet or chuck generally comprises a plurality (i.e. two or more) chucking elements which are actuated, particularly forced apart, by a guiding and/or actuation element, e.g. by a piston engaging oblique inner surfaces of the chucking elements. When the guiding and/or actuation element is moved from a starting position to an end position, it pushes the chucking elements apart against a force applied by a tensioning element.

The jacket comprises at least a window, particularly a plurality of windows corresponding to the number of chucking element in order to allow the actuated chucking elements to move outside through the windows, to protrude the outer surface of the jacket and to engage positively with the inner wall surface of the upper first section of the pipette tip. There may be a positive fit, a form fit or a frictional contact between the chucking elements and the inner surface of the upper first section of the pipette tip.

The guiding and/or actuation element may have various designs. Some of these designs are illustrated in the appended drawings.

Furthermore, the coupling device comprises at least one tensioning element for retracting the chucking elements when the guiding and/or actuation element is retracted into the starting position.

### BRIEF DESCRIPTION OF THE DRAWINGS

The present disclosure will be explained in greater detail with reference to the exemplary embodiments which are illustrated in the drawings. The figures show:

FIG. 1 a perspective view of a first embodiment of a coupling device according to the present disclosure;

FIG. 2A a sectional view of the first embodiment in a first state;

FIG. 2B a sectional view of the first embodiment in a second state;

FIG. 3A a top sectional view of a second embodiment of a coupling device according to the present disclosure;

FIG. 3B a side view of the second embodiment;

FIG. 4A a sectional view of a third embodiment of a coupling device according to the present disclosure in a second state;

FIG. 4B a sectional view of the third embodiment in a first state;

FIG. 5A a bottom perspective view of a fourth embodiment of a coupling device according to the present disclosure;

FIG. 5B a top perspective view of the fourth embodiment;

FIG. 5C a transverse sectional view through the chuck of the fourth embodiment;

FIG. 5D a side view of the fourth embodiment;

FIG. 5E a longitudinal sectional view of the fourth embodiment;

FIG. 5F another side view of the fourth embodiment;

FIG. 5G a combined side view and sectional vier of the fourth embodiment;

FIG. 6A top view of a fifth embodiment of a coupling device according to the present disclosure;

FIG. 6B a side view of the fifth embodiment;

FIG. 6C a sectional side view of the fifth embodiment in a second state;

FIG. 6D a sectional side view of the fifth embodiment in a first state;

FIG. 7A top view of a sixth embodiment of a coupling device according to the present disclosure;

FIG. 7B a side view of the sixth embodiment;

FIG. 7C a sectional side view of the sixth embodiment in a second state;

FIG. 7D a sectional side view of the sixth embodiment in a first state;

FIG. 8 a first embodiment of a tensioning element of a chuck;

FIG. 9 a second embodiment of a tensioning element of a chuck;

FIG. 10 a third embodiment of a tensioning element of a chuck;

FIG. 11 a first embodiment of an actuation element;

FIG. 12 a second embodiment of an actuation element;

FIG. 13 a third embodiment of an actuation element;

FIG. 14 a first embodiment of a contact surface of an actuation element;

FIG. 15 a second embodiment of a contact surface of an actuation element;

FIG. 16 a third embodiment of a contact surface of an actuation element.

### DETAILED DESCRIPTION

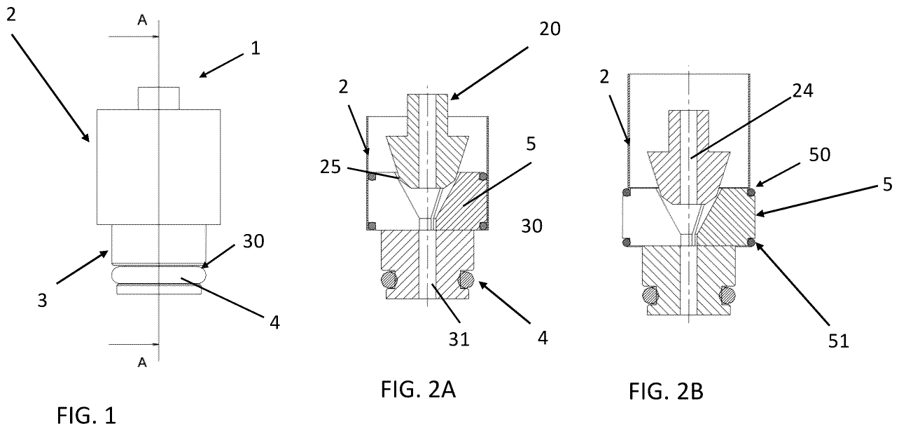

FIG. 1 illustrates an inventive coupling device 1 having a jacket 2 and a basic body portion 3. Inside the jacket 2 there are three (3) chucking elements. Correspondingly, the jacket 3 comprises three windows (not shown in the drawing).

Near the bottom of the basic body portion 3 a sealing ring 4 (e.g. O-Ring) is provided for engagement with an inner sealing surface of a pipette tip (not shown in the drawing). The sealing ring 4 may be positioned in a groove 30 formed in the basic body portion 3.

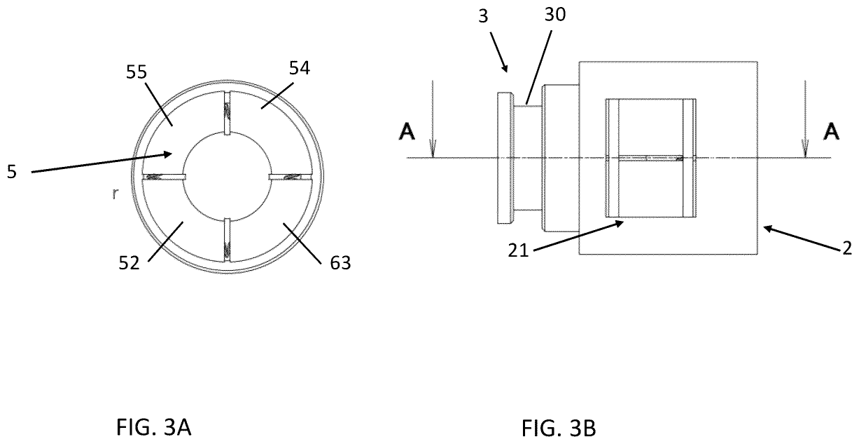

FIGS. 2A and 2B illustrate a sectional view of the same coupling device 1. The coupling device 1 has an actuation element 20, e.g. a piston, and a chuck 5. For example, the chuck 5 includes three (3) moveable chucking elements. In FIG. 2A/2B the coupling device 1 is in a start position (first state) of the actuation element 20, i.e. the actuation element 20 is in a retracted position, and thus the chucking elements are in a retracted state. In FIG. 3 the coupling device 1 is in an end position (second state), i.e. the chucking elements are in an expanded state. In this embodiment there are two (2) tensioning elements 50, 51, e.g. elastic ring elements. The tensioning elements may be O-Rings 50, 51 that are arranged in respective grooves formed in the chucking elements. The tensioning elements 50, 51 may be flexible such that the radial extension of the tensioning elements 50, 51 may be altered when a force is applied by an expanding mechanism (piston 20, chuck 5) of the coupling device 1.

The O-Rings 50 and 51 are axially offset. The present disclosure is not limited to a particular number of tensioning elements. When the external force exerted to the chucking elements is released, the tensioning elements 50, 51 retract the chucking elements to the first state.

FIGS. 3A and 3B illustrate a sectional view and a side view, respectively, of a second embodiment of a coupling device 1. The coupling device 1 is similar to the one of FIGS. 1, 2A, 2B. However, the coupling device 1 of the second embodiment has a collet comprising four (4) chucking elements 52, 53, 54, 55. Furthermore, in this embodiment, a window 21 formed in the jacket 2. The basic body portion 3 does not comprise a sealing element provided in the groove 30.

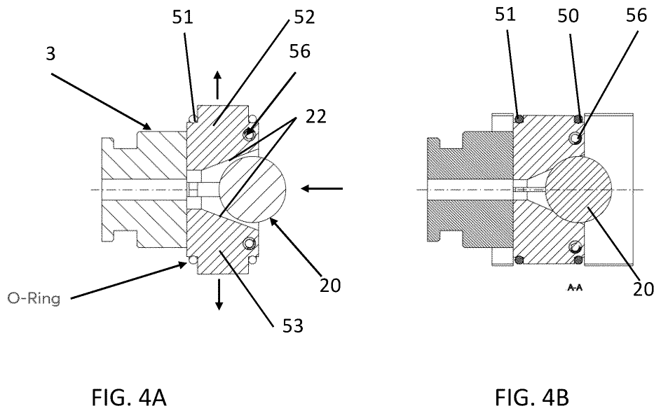

FIGS. 4A and 4B illustrate in a sectional view of a third embodiment of a coupling device 1 according to the present disclosure in an end position (second state) and in a start position (first state), respectively. The actuation element 20 is a ball which is in contact with oblique surfaces 22 of the chucking elements 52, 53. Furthermore, a spring 56 is provided to act as a tensioning element.

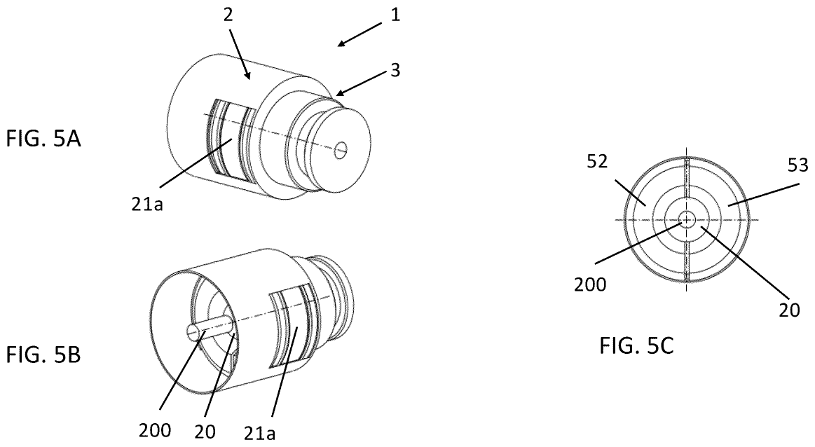

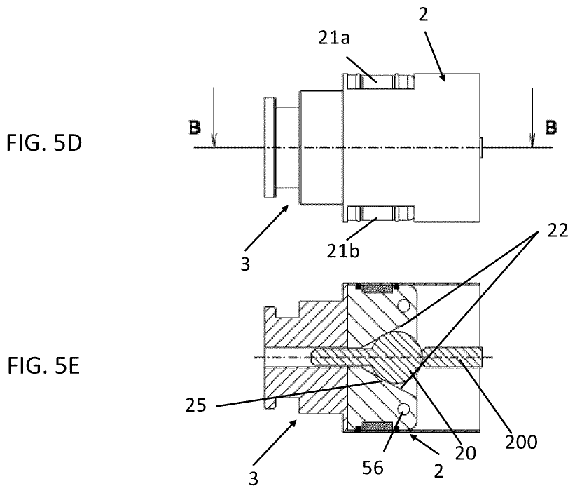

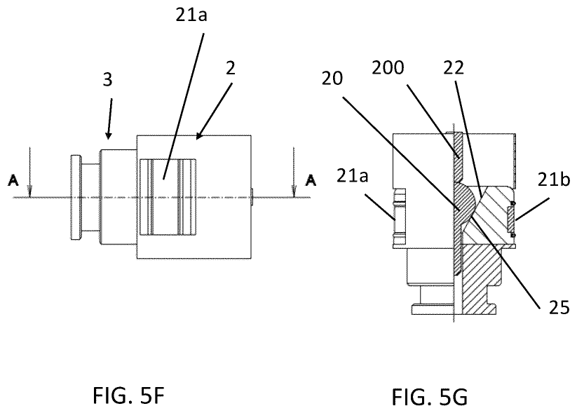

In the end position (second state, FIG. 4A) the actuation element 20 is pushed forward and the chucking elements, e.g. 52, 53, are in an expanded position, whereas in the start position (first state, FIG. 4B) the actuation element 20 is retracted and the chucking elements, e.g. 52, 53, are retracted as well. In the first state the tensioning elements (one or more of the O-rings and springs 50, 51, 56) exert a force to the chucking element 52, 53, etc. and retract them actively into the retracted position. FIGS. 5A-5G illustrate a fourth embodiment of the present disclosure. The coupling device 1 has a collet comprising two (2) chucking elements 52, 53. The jacket 2 has windows 21a, 21b in the cylindrical side wall of the jacket 2 in order to allow the chucking elements 52, 53 to expand and pass through the respective window 21a, 21b and to protrude from the respective window 21a, 21b.

FIGS. 5E and 5G illustrate sectional vies/aspects of the coupling device 1. In the fourth embodiment of a coupling device 1 according to the present disclosure an actuation element 20 is provided which has the shape of a ball which is in contact with oblique surfaces 22 of the chucking elements 52, 53. The actuation element 20 is actuated by means of a rod 200.

In an end position (second state) the actuation element 20 is pushed forward towards basic body portion 3 and the chucking elements 52, 53 are moved into an expanded position, whereas in a start position (first state) the actuation element 20 is retracted and the chucking elements 52, 53 are retracted.

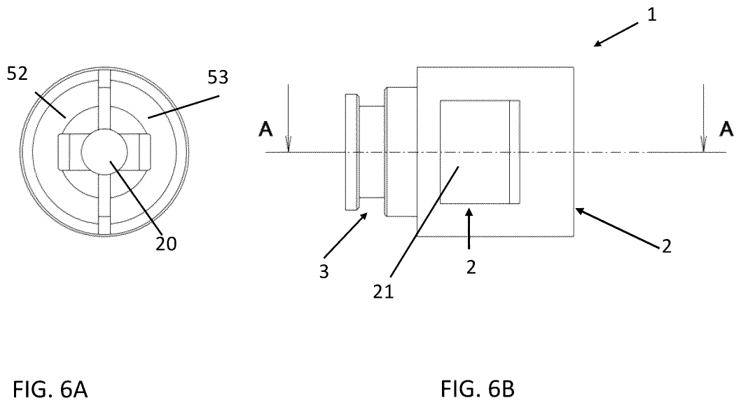

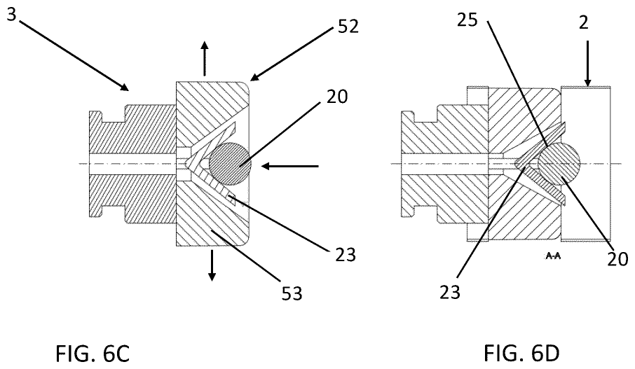

FIGS. 6A, 6B, 6C and 6D show a fifth embodiment of the present disclosure.

The coupling device 1 has a collet comprising two (2) chucking elements 52, 53. In this embodiment a window 21 is formed in the jacket 2. The basic body portion 3 does not comprise a sealing element.

In this embodiment the coupling device 1 comprises a clamp 23 which is operated by a ball 20 to move the chucking elements 52, 53 from a retracted position (FIG. 6D) to an engagement position (FIG. 6C). In the engagement position the chucking elements 52 and 53 are pressed outwardly by the clamp 23 which is moved towards the basic body portion 3 by the ball. The clamp 23 may be elastically deformable to a certain extent.

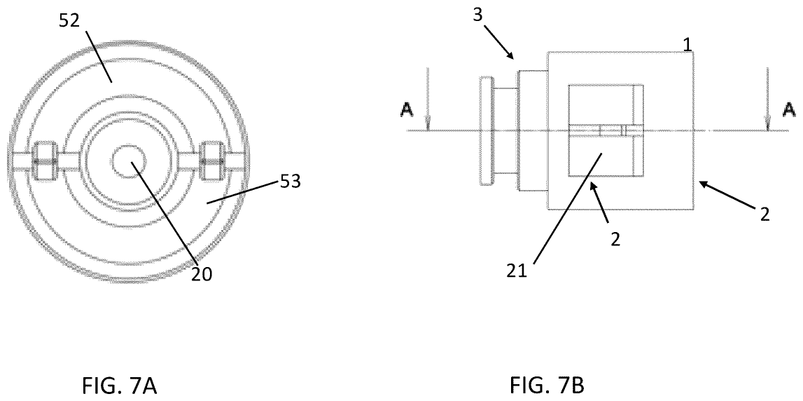

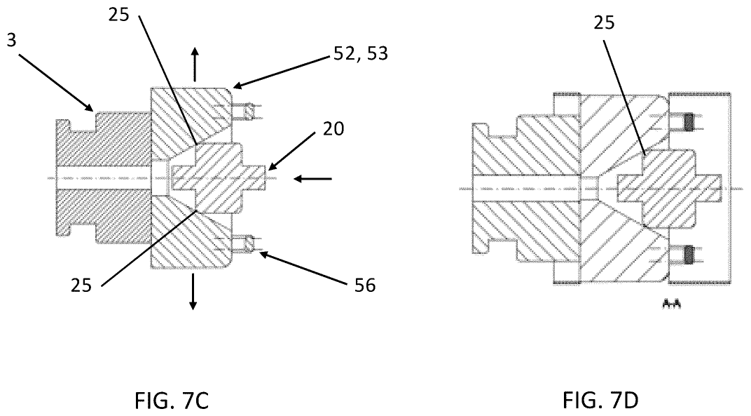

FIGS. 7A, 7B, 7C and 7D show a sixth embodiment of a coupling device 1 having a guiding and actuation element 20, e.g. a piston, which, in a sectional view, has a cross-like shape.

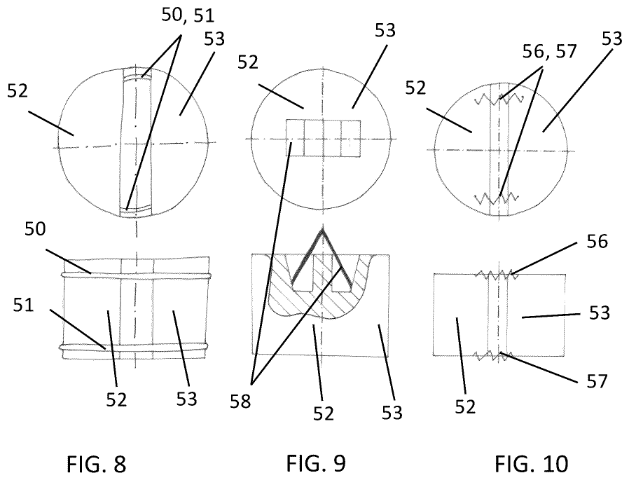

Generally, elastic elements and tensioning elements 50, 51, 56, 57, respectively, may comprise at least one of springs, O-rings, clamps, sealing elements (elastic), etc. The following FIGS. 8, 9 and 10 show O-rings 50, 51, a clamp 58 and springs 56, 57, respectively. These elements urge the chucking elements to move towards each other.

The jacket may comprise at least one window or opening for passage of the chucking elements 52, 53.

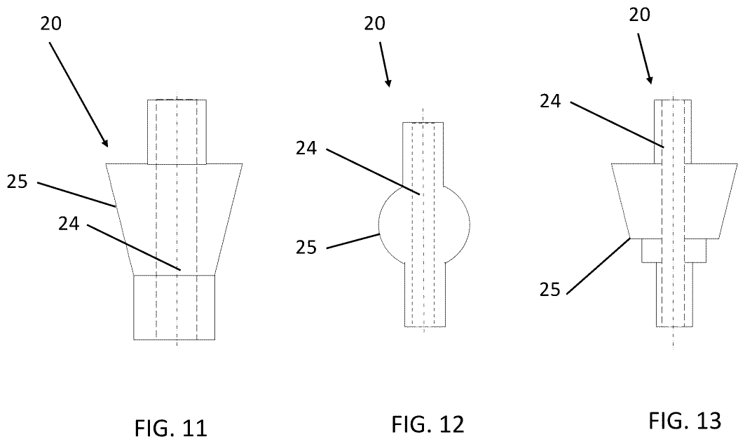

The guiding and/or actuation elements 20 may have various shapes. FIGS. 11, 12, 13 illustrate some exemplary shapes. The guiding and/or actuation elements 20 have an inner channel 24. The inner channel communicates with another inner channel 31 of the main body portion 3 (cf. e.g. FIGS. 2A and 2B). The channels 24, 31 are provided for aspirating fluid from a volume or for inserting a fluid into a volume.

The contact surfaces 25 for contacting corresponding surfaces of the chucking elements 52, 53 are usually small, so low-friction sliding contact with the chucking elements 52, 53 is provided. Some examples of contact surfaces 25 contacting a corresponding surface of the chucking elements 52, 53 are shown in FIGS. 2A, 5E, 6D, 7C, 7D. Furthermore, the shape is adapted such that self-locking effects are avoided.

The guiding and/or actuation element 20 may be provided at least partly with a surface having good gliding properties. E.g the surface may be coated with a guiding coating. It may be polished (either coated or not coated).

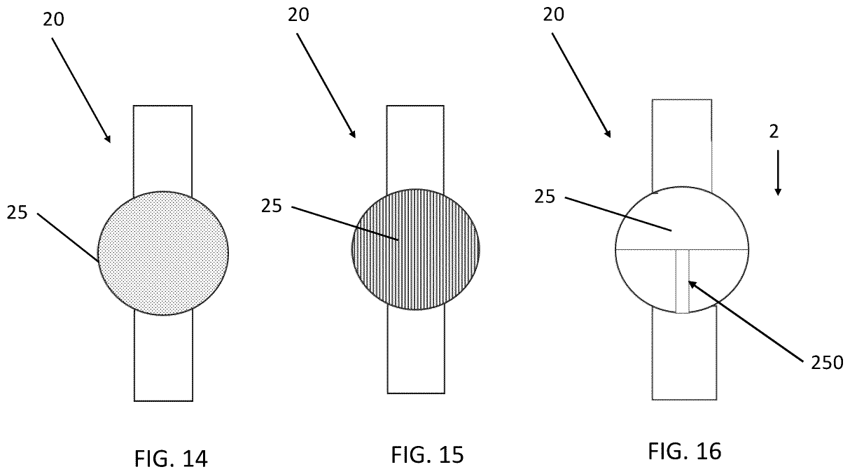

For example, as shown in FIG. 14, the guiding and/or actuation element 20 (or parts thereof) may be structured in order to reduce the overall contact between the guiding and/or actuation element 20 and the chucking element(s) 52, 53. The structure effects kind of a lotus effect.

In another example, as shown in FIG. 15, the structure may be grooves having the same effect, namely, reduce the gliding friction.

In another example, as shown in FIG. 16, the guiding and/or actuation element 20 comprises openings 250 arranged along the circumference of the guiding and/or actuation element 20.

Within the recesses, grooves or openings 250 formed in the guiding and/or actuation element 20 there may be coatings which promote the sliding properties of the components. Such or similar structures may be formed in surface areas 22 of the chucking elements 52, 53 contacting the guiding element 20, instead of the structure 25 formed in the guiding element 20 or in addition to the structure 25 formed in the guiding element 20.

In all embodiments of the present disclosure the profile, the shape and the outer surface of the chucking element 52, 53 is adapted to the inner wall of a first upper section of a pipette tip, wherein the inner wall section is particularly complementary with the outer surface of the chucking elements 52, 53.

All features described in different embodiments of the present disclosure may be combined arbitrarily and be comprised within the scope of this disclosure. Identical reference numbers denote the same (functional) components.

1. A coupling device of a pipetting robot for coupling to a pipette tip, wherein the coupling device comprises:
a jacket comprising a hollow in which a collet or chuck is arranged, wherein the collet or chuck comprises a plurality of chucking elements;
a guiding and/or actuation element configured to force the plurality of chucking elements apart when the guiding and/or actuation element is moved from a first position into a second position; and
at least one tensioning element configured to retract the chucking elements when the guiding and/or actuation element is retracted into the first position.

2. The coupling device of claim 1, wherein the guiding and/or actuation element is configured to force apart the plurality of chucking elements by engaging oblique inner surfaces of the chucking elements.

3. The coupling device of claim 1, wherein the guiding and/or actuation element comprises a piston.

4. The coupling device of claim 1, wherein the guiding and/or actuation element comprises a ball component.

5. The coupling device of claim 2, wherein the guiding and/or actuation element comprises a clamp positioned between the guiding and/or actuation element and the oblique inner surfaces of the chucking elements.

6. The coupling device of claim 1, wherein the guiding and/or actuation element comprises a contact surface having an anti-friction structure and/or a friction reducing structure.

7. The coupling device of claim 1, wherein the tensioning element includes an O-ring, a clamp, and/or a spring.

8. The coupling device of claim 1, wherein the jacket comprises at least one window configured to allow the chucking elements to move outside through the window, to protrude to an outer surface of the jacket and to engage positively with an inner wall surface of a pipette tip.

9. The coupling device of claim 8, wherein a number of the at least one windows corresponds to a number of the plurality of chucking elements.

10. The coupling device of claim 1, wherein the coupling device comprises a main body portion connected to the jacket.

11. The coupling device of claim 10, wherein main body portion comprises a groove configured to receive a sealing element.
